(19) United States
(12) Patent Application Publication
(10) Pub. No.: US 2024/0403402 A1
(43) Pub. Date: Dec. 5, 2024

(54) Authentication Continuity

(71) Applicant: Apple Inc., Cupertino, CA (US)

(72) Inventors: Martin Haller, Mountain View, CA (US); Andrei Nikiforov, Berlin (DE); Benjamin Biron, Saratoga, CA (US); Kyle C. Brogle, San Francisco, CA (US); Lucie Kucerova, Chodoun (CZ); Oliver G. Wenisch, Potsdam (DE); Petr Kostka, Prague (CZ); Tom Sengelaub, Oakland, CA (US); Tomislav Suchan, Sunnyvale, CA (US)

(21) Appl. No.: 18/733,414

(22) Filed: Jun. 4, 2024

Related U.S. Application Data
(60) Provisional application No. 63/506,300, filed on Jun. 5, 2023.

(51) Int. Cl. G06F 21/32

(52) U.S. Cl. CPC G06F 21/32

(57) ABSTRACT

Techniques are disclosed relating to devices that support biometric authentication. In various embodiments, a device includes a biosensor configured to collect biometric data from a user. An authentication system of the device is configured to perform a user authentication based on the collected biometric data. After performance of the user authentication, the authentication system receives sensor data indicating that the user remains collocated with the device and receives a request to confirm an authentication of the user. Based on the user authentication and the received sensor data, the authentication system confirms that the user has been authenticated. In various embodiments, the authentication system is configured to receive additional sensor data indicating that the user is no longer collocated with the device and, in response to a subsequent authentication request, require the user to perform another biometric authentication using the biosensor.

The present application claims priority to U.S. Prov. Appl. No. 63/506,300, entitled “Authentication Continuity,” filed Jun. 5, 2023, which is incorporated by reference herein in its entirety.

### BACKGROUND

### Technical Field

This disclosure relates generally to user authentication, and, more specifically, to devices that support biometric authentication.

### Description of the Related Art

User authentication typically relies on a user providing one or more credentials attesting to the user's identity. For example, a user attempting to log into a device may supply a password before being permitted access to the device. In an effort to reduce the burden on a user, some devices may support authenticating a user via biometric data captured from the user. For example, a mobile device may include a fingerprint sensor configured to collect fingerprint biometric data, which may be compared with stored fingerprint information of a known user. Being able to supply authentication information other than typing in a password, for example, may be advantageous as it allows a user to authenticate more quickly and seamlessly.

### BRIEF DESCRIPTION OF THE DRAWINGS

FIG. 1 is a block diagram illustrating one embodiment of a computing device configured to implement authentication continuity.

FIG. 2 is a block diagram illustrating an exemplary timeline associated with extending the period in which a user is identified as being authenticated based on sensor data of the device.

FIG. 3 is a block diagram illustrating embodiments of routing biometric data and sensor data to an authentication system of the computing device.

FIG. 4 is a flow diagram illustrating one embodiment of an authentication policy evaluation performed by the computing device.

FIGS. 5A-5C are flow diagrams illustrating embodiments of methods, which may be performed by the computing device.

FIG. 6 is a block diagram illustrating one embodiment of an exemplary device, which may implement the computing device.

FIG. 7 is a block diagram illustrating one embodiment of a secure enclave processor, which may implement the authentication system of the computing device.

### DETAILED DESCRIPTION

As a user interacts with a computing device, the user may request performance of particular operations that warrant reauthenticating the user in order to confirm that someone else has not begun using the device. For example, a user might initially authenticate with a device to unlock it and later request the device use a stored authentication credential to authenticate to a website being displayed in a browser. As an added level of security, the device may ask the user to reauthenticate before releasing the credential. Continually asking the user to reauthenticate, however, can become a nuisance for the user. This can be particularly true for some forms of biometric authentication that may involve greater interaction from the user. For example, facial recognition may include asking a user to reposition a face in front of a camera for a sustained period. As another example, iris scanning may include asking the user to maintain a forward focus into a camera for some sustained period while also maintaining a particular head orientation, upright posture, etc. As such, it may be desirable to reduce the number instances in which a user is asked to authenticate.

The present disclosure describes embodiments in which a device analyzes sensor data to extend a period in which a user is identified as authenticated based on the sensor data indicating that the user remains collocated with the device. As will be described below in various embodiments, a device can include a biosensor configured to collect biometric data from a user and an authentication system configured to perform a user authentication based on the collected biometric data. In response to the user authentication being successful, the authentication may indicate, for an initial time period, that the user has been successfully authenticated in response to a received authentication request. After performance of the user authentication, the authentication system can continually analyze sensor data to determine that the user remains collocated with the device. Based on this analysis, the authentication system may determine to extend the time period in which it indicates that the user has been authenticated. Accordingly, if an authentication request is received during this extended time period, the authentication system may confirm that the user has been authenticated without asking the user to perform another biometric authentication.

In many instances, extending the period in which a user is deemed to be authenticated (referred to herein as “authentication continuity”) may greatly improve the user experience as the user is not repeatedly asked to reauthenticate each time a user wants to perform some operation that warrants additional security.

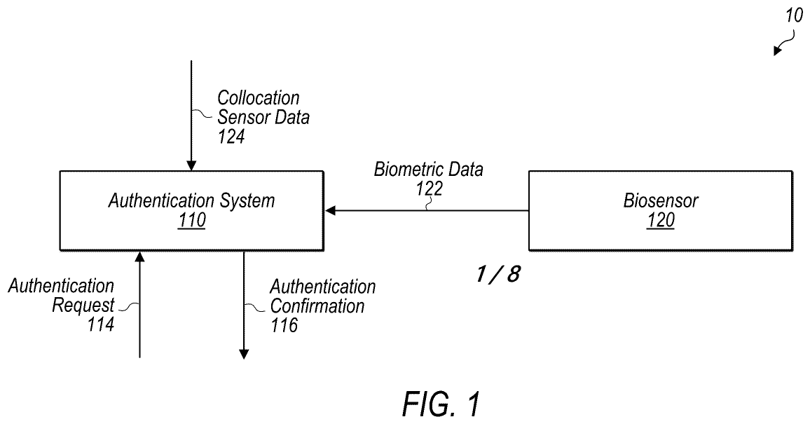

Turning now to FIG. 1, a block diagram of a computing device 10 configured to implement authentication continuity is depicted. In the illustrated embodiment, device 10 includes an authentication system 110 and a biosensor 120. In some embodiments, device 10 may be implemented differently than shown.

Device 10 may correspond to any suitable device that employs user authentication. In some embodiments, device 10 is a mobile device such as a mobile phone, tablet computer, handheld computer, music player, laptop or notebook computer, personal data assistant (PDA), consumer device, etc. In some embodiments, device 10 is an internet of things (IoT) device, server system, desktop computer, mainframe computer system, workstation, network computer, etc. In some embodiments discussed below, device 10 is a wearable device such as a watch, athletic sensor, or a head mounted display, which may be a headset, helmet, goggles, glasses, a phone inserted into an enclosure, etc. In some embodiments, device 10 is a vehicle such as an aircraft, marine vessels, recreational vehicles (RVs), automobiles, buses, railed vehicles, spacecraft, robotic devices, trucks, trailers, cranes, caterpillars, etc.

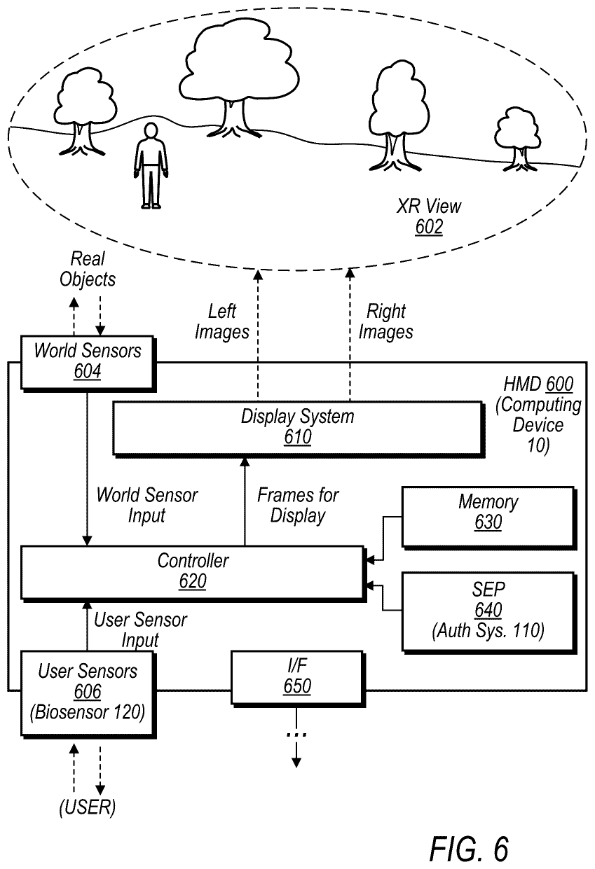

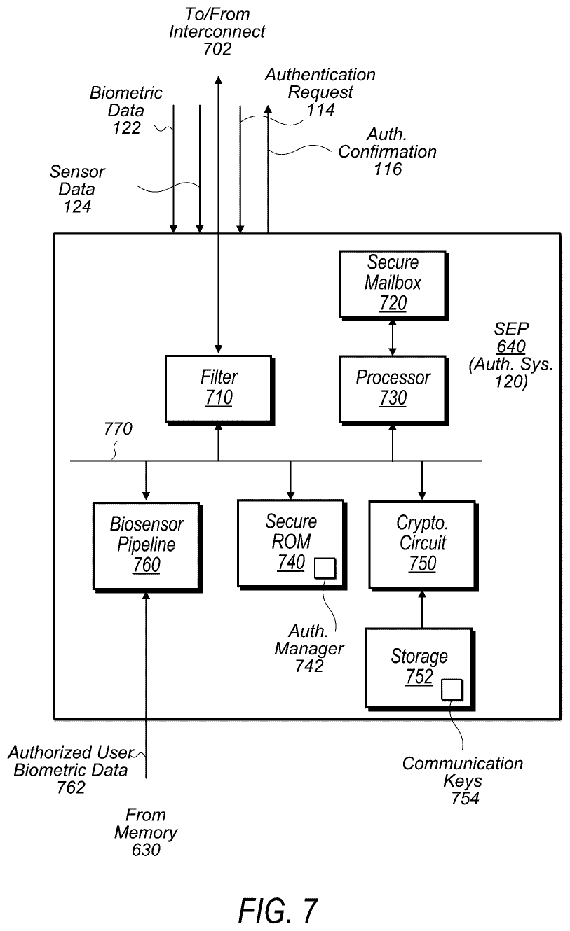

Authentication system 110 is a system configured to determine whether a user of device 10 is an authorized user. As will be discussed below with FIGS. 6 and 7, authentication system 110 is implemented using circuitry, a memory having program instructions stored therein, or a combination thereof. As shown, authentication system 110 may receive authentication requests 114 asking it to confirm whether a current user is authentic and may provide corresponding authentication confirmations 116. Requests 114 may originate from any of various sources within device 10, such as an operating system, applications executing on device 10, secured peripherals, etc. and, in some embodiments, may be received via an application programming interface supported by system 110. Requests 114 may also be issued for any of various operations/actions such as unlocking/logging into device 10, opening particular applications, accessing confidential/secured information (e.g., stored authentication credentials, encrypted files, payment credentials, etc.), performing tasks with elevated privileges, etc. In some embodiments, system 110 may merely issue a response/confirmation 116 indicating that a user has been successfully (or unsuccessfully) authenticated. In other embodiments, system 110 may issue a confirmation 116 including information that enables performance of a requested action. For example, if a user is requesting access to an encrypted file/data, authentication system 110 may confirm that a user is authentic and then derive a cryptographic key using internal circuitry (as will be discussed with FIG. 7) used to decrypt the file. System 110 may then issue a confirmation 116 including the decrypted file (or a decryption key for accessing the file). Authentication system 110 may also support any suitable form of authentication. In some embodiments, authentication system 110 is configured to authenticate a user based on a supplied secret known to an authorized user such as password, passcode, personal identification number (PIN), token, etc. Authentication system 110 may also support authentication using public-key cryptography, which may include a challenge response exchange with a key presented by a user. As will be discussed below, authentication system 110 may also be configured to perform biometric authentications via biosensor 120.

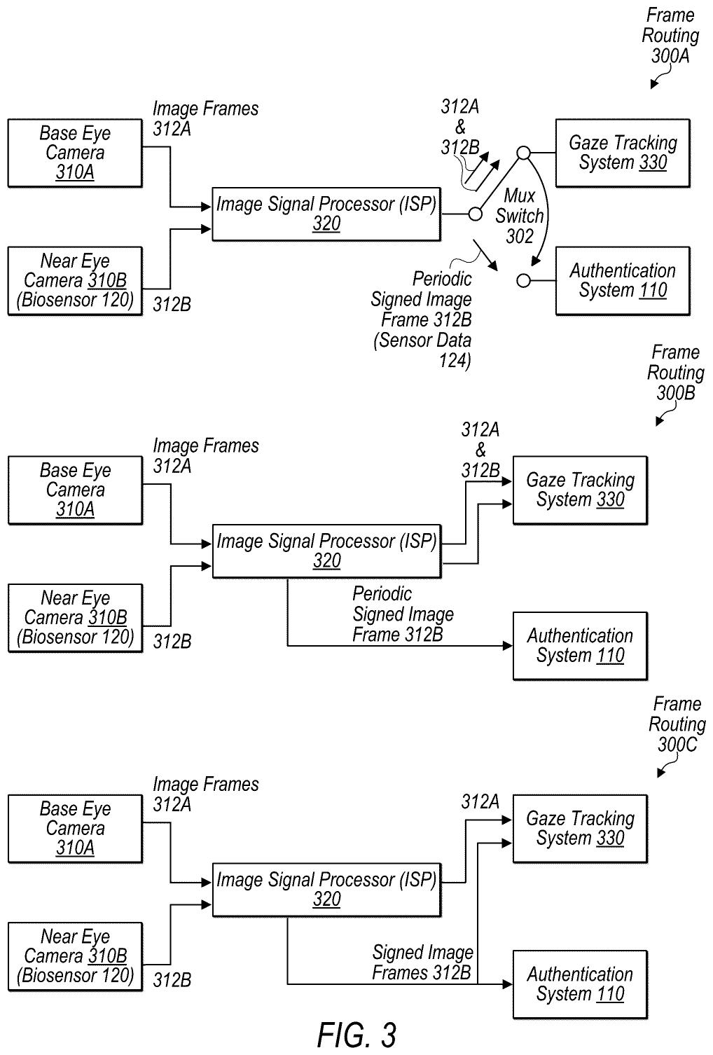

Biosensor 120 includes one or more sensors configured to collect biometric data from a user. As used herein, “biometric data” refers to data that uniquely identifies the user among other humans (at least to a high degree of accuracy) based on the user's physical or behavioral characteristics. In some embodiments, biosensor 120 is a camera configured to collect facial data of a user's face in order to perform facial recognition. As will be discussed below with FIG. 3, in some embodiments, biosensor 120 includes cameras configured collect images of a user's eyes in order to perform iris recognition. In some embodiments, the iris recognition is based on images collected from a single one of the user's eyes; in other embodiments, the iris recognition is based on images collected from both the user's eyes. In still other embodiments, biosensor 120 may be configured to collect other forms of biometric data such voice recognition data, fingerprint data, vein data, etc. In various embodiments, authentication system 110 is configured to compare biometric data 122 collected from a current user to stored biometric data of an authorized user in order to determine whether the current user is authentic.

As noted above, repeatedly asking the user to authenticate using authentication system 110 and biosensor 120 may become a nuisance if a user is repeatedly asking to perform actions that warrant confirmation of the user's identity.

As will be discussed below in various embodiments, authentication system 110 is configured to extend a period in which a user is identified as authenticated based on collocation sensor data 124 received after performance of a user authentication. In particular, system 110 may periodically receive sensor data 124 indicating whether a user is collocated with device 10 and may analyze data 124 to confirm that the user has continuously remained collocated with the device 10—thus indicating that the user is likely the same user that was previously authenticated. For example, if device 10 is a wearable device, system 110 may analyze sensor data 124 to determine whether a user is still wearing device 10. If system 110 determines that user has remained collocated and a request 114 is received, system 110 may provide a corresponding authentication confirmation 116 indicating that the user is authentic without instructing the user to perform another authentication. If, however, system 110 has determined, based on sensor data 124, that a user has not remained collocated with device 10, system 110 may provide a corresponding authentication confirmation 116 indicating that a user is no longer authenticated—and, in some embodiments, may ask the user to reauthenticate.

Authentication system 110 may receive collocation sensor data 124 from any suitable sources. In some embodiments, sensor data includes data provided by biosensor 120, which may include a subset of biometric data 122 or distinct data collected by biosensor 120. For example, in embodiments discussed below with FIG. 3, sensor data 124 may include an image captured by a camera of biosensor 120 of a user's eye in order for authentication system 110 to determine that the user's eye remains in a field of a view of the camera. In various embodiments, sensor data 124 includes sensor data provided from one or more sensors other than biosensor 120. For example, in some embodiments, device 10 includes a proximity sensor configured to provide sensor data 124 indicative of a proximity of the user to the device. Such a sensor may employ sonar, passive infrared (PIR), LIDAR, etc. to detect a user's presence and determine whether the user remains proximal to the device—e.g., within some threshold range of device 10. In some embodiments, device 10 includes a skin contact sensor configured to provide sensor data 124 indicative of whether the user's skin is contacting device 10 and usable to determine whether the user's skin remains in contact after an authentication. In some embodiments, device 10 includes a camera configured to provide sensor data 124 including captured images of the user and usable to determine that a portion of the user remains in a field of view of the camera.

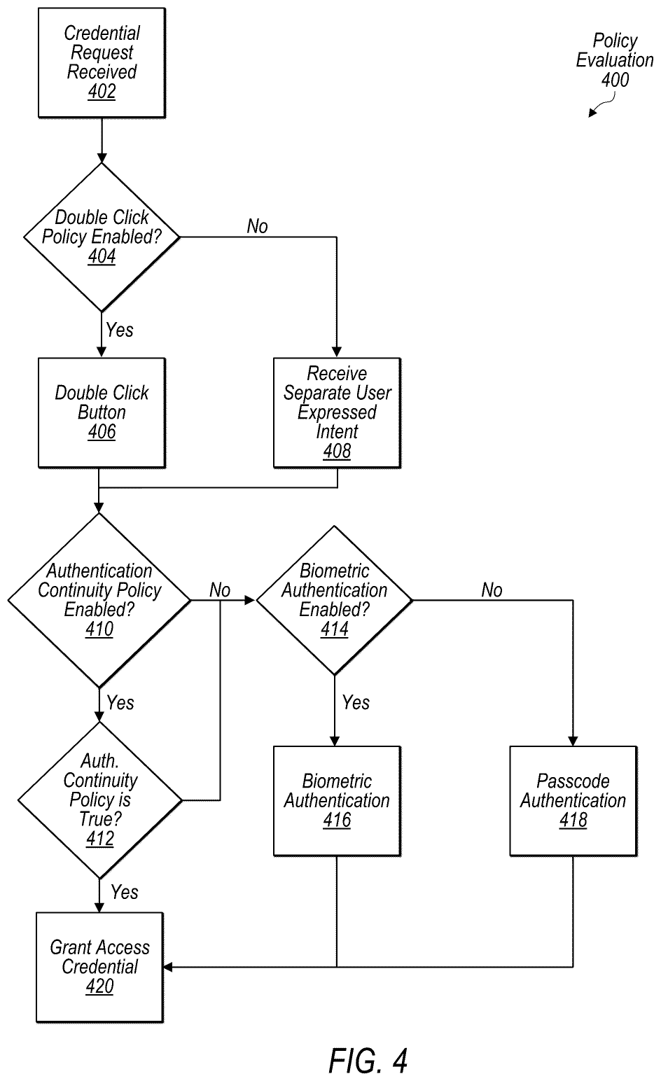

In some embodiments, authentication system 110 may evaluate different policies to determine whether to extend a period in which a user is identified as authenticated. These policies may specify different criteria for expending the period based on, for example, the action/operation being requested by the user, prior settings established by an authorized user (or a manufacturer), the manner in which the user was previously authenticated, etc. For example, authentication system 110 may perform an initial authentication that is not based on biometric data 122 such as passcode-based authentication. Authentication system may then receive an indication that a user has requested a particular action such as accessing a payment credential securely stored in device 10. Based on stored policies, system 110 may ask the user to perform a step-up authentication in which the user additionally performs a biometric authentication before being allowed to perform the particular action. An exemplary authentication policy evaluation will be discussed in greater detail below with FIG. 4.

An exemplary sequence of events associated with extending a user's authentication period will be discussed next.

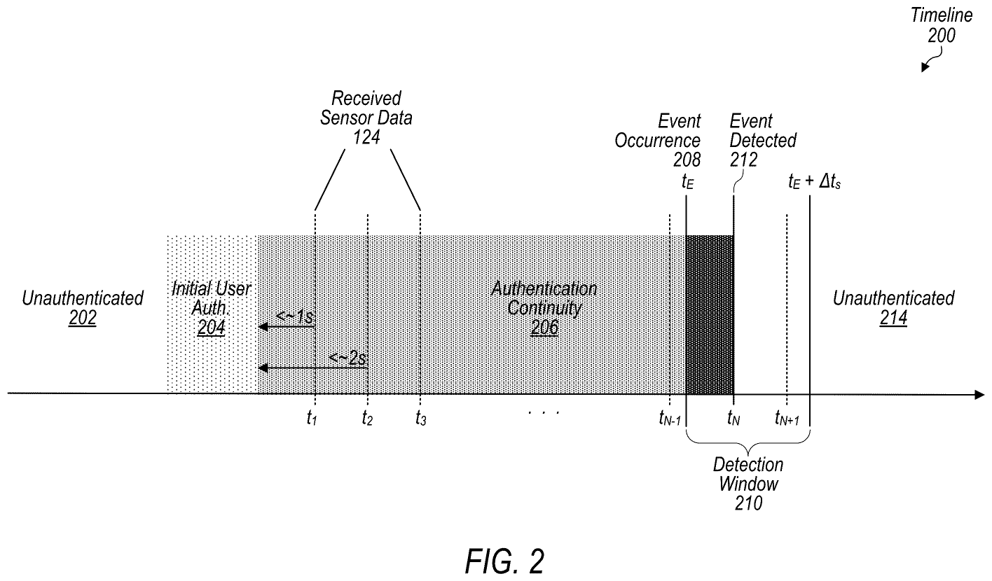

Turning now to FIG. 2, a block diagram of an exemplary timeline 200 is depicted. In the illustrated embodiment, exemplary timeline 200 represents a sequence of events in which a user becomes authenticated and continues to be identified as authenticated until an event occurs that warrants a reauthentication. In some embodiments, timeline 200 may be implemented differently.

As shown, timeline 200 may begin with a user being in an unauthenticated state 202. In some instances, a user may be in this state as no prior authentication has been performed—e.g., a user may have just powered on device 10. In other instances, a user may have previously authenticated but performed some action that takes a user out of an authenticated state. In some embodiments, a user may also be in this state for performing a type of authentication that is determined to be unacceptable based on a stored policy associated with a particular action such as having performed a passcode authentication when the policy specifies a biometric authentication for granting the particular action.

Based on a user's interaction with device 10, device 10 may request that authentication system 110 perform an initial user authentication 204. In some instances, this authentication may be a biometric authentication based on biometric data 122 collected by biosensor 120. In other instances, this authentication may be based on some other authentication factor such as those noted above. As shown, authentication system 110 may determine to indicate, for an initial indication period, that the user has been authenticated before considering additional sensor data 124 or requiring a reauthentication. In some embodiments, this initial period may be relatively short such as a second or two.

After performing the authentication, authentication system 110 may receive periodic captured samples of the sensor data 124 at times t1, t2, t3, and so forth. In the illustrated embodiments, these samples are received at one second internals; however, other embodiments may use a different cadence. As samples are received, authentication system 110 may analyze them to determine whether the same user remains collocated with device 10. For example, in an embodiment in which device 10 is a wearable device, authentication system 110 may analyze the received sets of sensor data 124 to confirm that the sensor data 124 indicates that the user continues to wear device 10. Based on the periodically captured samples indicating that the same user remains present, authentication system 110 may determine to extend the indication period, shown as authentication continuity 206, without requesting another user authentication.

As authentication system 110 continually analyzes sensor data 124, however, an event 208 may occur in which the authenticated user is no longer in possession of device 10 (or, at least, sensor data 124 indicates that the user is no longer present). For example, an authenticated user may have set device 10 down, walked away from device 10, handed device 10 to someone else, etc. Depending on the cadence of sensor data 124, authentication system 110 may detect the event at some point within a detection window 210. For example, at time tₙ, authentication system 110 may determine, from a received set of sensor data 124, that it can no longer identify the presence of the authenticated user shown as event detection 212.

In response to determining that the user no longer remains collocated with device 10, authentication system 110 may determine to discontinue indicating that the user has been authenticated resulting in the user transitioning to an unauthenticated state 214. In some embodiments, authentication system 110 may allow for a grace period in which it will resume indicating that a user is authenticated if sensor data 124 identifying the user's presence is received within detection window 210. In other embodiments, however, authentication system 110 may require to the user to reauthenticate once the user is in an unauthenticated state 214.

As will be discussed, device 10 may use sensor data 124 for purposes other than merely identifying that an authenticated user remains with device 10. As a result, sensor data 124 may be provided to components other than merely authentication system 110. In some embodiments, in order to ensure that sensor data 124 is authentic and unaltered for assessing a user's authenticity, device 10 may employ one of multiple routing strategies as will be discussed next.

Turning now to FIG. 3, various examples 300 for routing sensor data 124 to authentication system 110 are depicted. In the illustrated embodiment, authentication system 110 is configured to authenticate a user by performing iris recognition and analyzes images of a user's eyes to determine whether a user remains collocated with device 10. As shown, device 10 may include one or more base eye cameras 310A, one or more near eye cameras 310B, image signal processor (ISP) 320, gaze tracking system 330, and authentication system 110. Although routing examples 300 are described with respect to iris recognition, examples 300 may be applicable to other embodiments in which other forms of biometric data 122 and/or sensor data 124 are collected. In some embodiments, different components may be used than those depicted in FIG. 3.

Base eye camera 310A is a camera configured to capture images frames 312A at the base of a user's eye in order to track movement of the eye over time to determine the user's gaze. In the illustrated embodiment, base eye camera 310A provides one of two types of streams of frames 312 assessed by gaze tracking system 330.

Near eye camera 310B is a camera configured to capture image frames 312B from in front of a user's eye. As shown, camera 310B may provide the second type of frames 312B being analyzed by gaze tracking system 330. In the illustrated embodiment, near eye camera 310B also implements biosensor 120 as it can provide a sequence of frames 312B to authentication system 110 to facilitate an iris recognition of a user being authenticated. In some embodiments, camera 310B also periodically provides an image frame 312B as sensor data 124 usable to determine whether the user remains collocated with device 10. Given these two sensitive tasks, in the illustrated embodiment, camera 310B also signs frames 312B using a private key stored internally to camera 310B in order to preserve frame integrity and identify camera 310B as the legitimate source of frames 312B. In some embodiments, camera 310B may further encrypt frames 312B in order to keep their contents secret.

ISP 320 is configured to process captured frames 312A and 312B to facilitate intake by gaze tracking system 330. Accordingly, ISP 320 may perform various operations that modify frames 312 such as compressing frames 312, applying noise reduction algorithms to frames 312, adjusting the lighting and coloring of frames 312, cropping frames 312, etc. In some embodiments, ISP 320 also includes a direct memory access (DMA) engine to provide image frames 312 from cameras 310 to tracking system 330 and authentication system 110. Because ISP 320 may modify the contents of frames 312B, ISP 320 may be in contention with preserving frame integrity for authentication system 110 as any modification of a signed frame 312B may result in the corresponding signature being invalidated as will be discussed.

Gaze tracking system 330 is a system configured to track a user's gaze (i.e., where a user is currently looking) based on image frames 312A and 312B. In some embodiments, system 330 may employ one or more convolutional neural networks to facilitating gaze tracking. In other embodiments, system 330 may employ other graze tracking techniques.

As noted above, authentication system 110 may use image frames 312B captured by camera 310B to perform a biometric authentication of a user as well as assessing authentication continuity. When performing the biometric authentication, in the illustrated embodiment, system 110 analyzes a sequence of multiple image frames 312B captured by camera 310B to compare an iris of the user with iris data captured from an iris of an authorized, trusted user. In some embodiments, this comparison may be performed using convolutional neural networks, which may be implemented by dedicated neural network circuitry included in system 110. In some embodiments, frames 312B used in the iris recognition may also be captured at a higher resolution (e.g., the full resolution supported by camera 310B) than the resolution of frames 312B assessed by graze tracking system 330 or later assessed by system 110 as sensor data 124. In some embodiments, system 110 may have more restrictive criteria for assessing frames 312B, such as requiring that a user's gaze be within 5 degrees of a center point, than frames 312B assessed by graze tracking system 330. When system 110 later determines whether to extend the period in which it identifies the user as authenticated, in the illustrated embodiment, system 110 analyzes a periodically received image frame 312B to determine that an eye of the user remains in a field of a view of camera 310B. In some embodiments, this analysis may further include comparing properties of the user's eye to an eye examined in a prior biometric authentication. In some embodiments, this analysis may use a single frame 312B received once a second; however, in other embodiments, different quantities of frames 312B may be received at different cadences. In some embodiments, system 110 may tolerate a 20-degree divergence from the center point (in contrast to the 5-degree divergence with the iris recognition). In various embodiments, authentication system 110's analysis of frames 312B also includes verifying signatures using a public key corresponding to the private key used by camera 310B to sign the frames 312B. Accordingly, if system 110 identifies an invalid signature in a frame 312B indicating that the frame 312B may have been tampered with or is not from camera 310B, system 110 may indicate that the authentication has failed (or discontinue indicating that the user has been successfully authenticated). In order to ensure that ISP 320's modification of frames 312B for gaze tracking system 330 does not result in signature invalidations (and thus the failure of a user authentication), device 10 may employ one of exemplary frame routings 300.

In frame routing 300A, a physical multiplexer switch 302 is used to periodically route a signed image frame 312B to authentication system 110. In such an embodiment, ISP 320 passes the image frame 312B through to switch 302 without alteration in order to preserve the integrity of the frame 312B for authentication system 110. Adjusting switch 302 to route the frame 312B to authentication system 110 may, however, produce a frame drop for graze tracking system 330.

In frame routing 300B, ISP 320 may alternately create a duplicate copy of a signed image frame 312B at an early stage in ISP 320's pipeline so that it can provide an unaltered copy of the frame 312B to authentication system 110. The copy that remains in ISP 320 can then be altered as gaze tracking system 330 may not, in some embodiments, perform signature verification.

In frame routing 330C, ISP 320 may periodically eject a signed image frame 312B prior to any modification so that it can be routed to authentication system 110. A duplicate copy, however, may be created outside of ISP 320 and routed to gaze tracking system 330 to avoid a frame drop. In such an embodiment, some post processing of image frame 312B may be moved into graze tracking system 330.

As noted above, authentication system 110 may implement authentication continuity based on particular stored policies. An example of a policy evaluation will be discussed next.

Turning now to FIG. 4, a flow diagram of an exemplary policy evaluation 400 is depicted. In the illustrated embodiment, policy evaluation 400 is performed to assess whether a user should be granted access to a requested credential. In some embodiments, this credential may be a payment credential used to participate in a payment transaction, an authentication credential used to authenticate to a remote service, etc. In other embodiments, policy evaluation 400 may employed for actions other than obtaining a user credential.

As shown, policy evaluation 400 begin at 402 with a request to access a securely stored credential being received. In some embodiments, a user may have been previously authenticated in order to make this request; however, the specific nature of this request may warrant further evaluation before it can be granted.

In response to receiving this request, authentication system 110 may determine whether a double click policy is enabled at 404. In some embodiments, before assessing whether authentication continuity has been maintained, authentication system 110 may initially ask that the user provide an expressed intent via a mechanical input of device 10 in order to ensure that the credential request has originated from the user (as opposed to some malicious process operating without authorization from the user). In the illustrated embodiment, a user may provide this expressed intent at 406 by double clicking a button of device 10 (e.g., a power button on device 10's side)—although other techniques may be used in other embodiments. Before instructing the user to provide this expressed intent, authentication system 110 may evaluate whether this policy is enabled as a user may disable such a feature, for example, if the user is unable to do so due to a physical restriction. If the policy is not enabled, authentication system 110 may use some other approach at 408 to confirm that the request originated from the user such as providing a verbal prompt over an audio system of device 10. Once the user has provided an expressed intent, evaluation may proceed to 410. In other instances, the nature of the request (e.g., the particular action being requested by the request) may not warrant an expressed intent from the user as indicated by the policy.

At 410, authentication system 110 evaluates a policy to determine whether authentication continuity is enabled. In some embodiments, authentication continuity is enabled only after an authorized user has determined to enroll in this feature as some users may elect to not implement this feature due to, for example, security concerns or other reasons. In some embodiments, the policy may stipulate that authentication continuity can be relied on only if a user has been previously authenticated in particular manner such as via biometric authentication and not via passcode authentication. Based on such a stored policy, authentication system 110 may determine that criteria for enabling authentication continuity have not been met and require the user to proceed to perform another authentication at 414.

If the authentication continuity policy is enabled and evaluates to true (i.e., the user has remained collocated with device 10) at 412, authentication system 110 may grant access to the requested credential at 420.

If authentication continuity policy is not enabled or evaluates to false, authentication system 110 may proceed to reauthenticate the user. At 414, authentication system 110 may determine whether biometric authentication is enabled—as biometric authentication may be disabled, in some embodiments, as a user preference, if this is the initial authentication after boot, etc. If enabled, authentication system may proceed at 416 to perform a biometric authentication before granting access to the credential at 420. If not enabled, system 110 may attempt to authenticate the user via some other technique such as via a passcode at 418 before proceeding to grant access at 420.

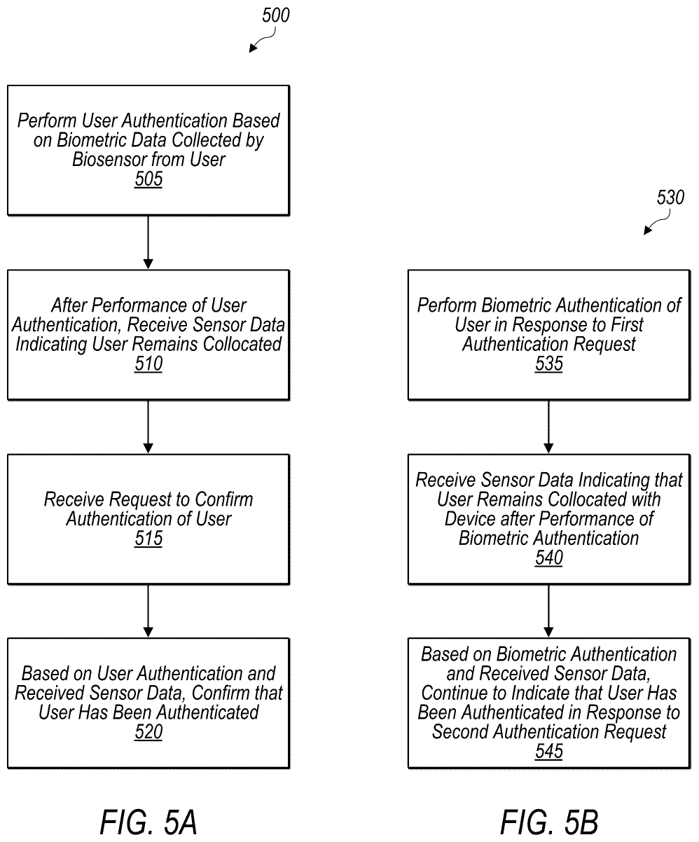

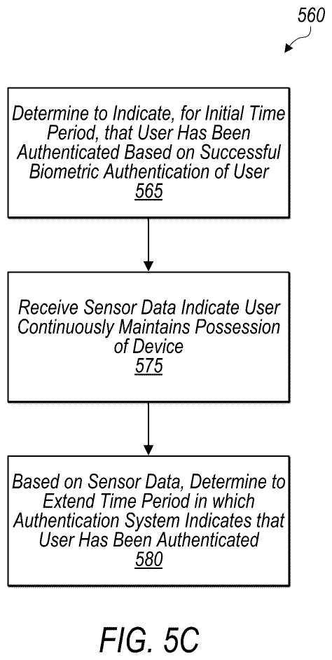

Turning now to FIG. 5A, a flow diagram of a method 500 is depicted. Method 500 is one embodiment of a method that may be performed by a device such as computing device 10. In many instances, performance of method 500 may reduce the burden on the user with respect to user authentication.

In step 505, an authentication system (e.g., authentication system 110) of the device perform a user authentication based on the biometric data (e.g., biometric data 122) from a user by a biosensor (e.g., biosensor 120). In some embodiments, the biosensor includes a camera (e.g., near eye camera 310B) configured to capture images of an eye of the user; the authentication system performs the user authentication by comparing an iris in a sequence of the captured images to an iris of an authorized user. In some embodiments, the camera is configured to provide ones of the captured images to the authentication system and provide ones of the captured images to a gaze tracking system (e.g., gaze tracking system 330) of the device.

In step 510, after performance of the user authentication, the authentication system receives sensor data (e.g., sensor data 124) indicating that the user remains collocated with the device. In various embodiments, the device is a wearable device; the authentication system analyzes the sensor data to confirm that the sensor data indicates that the user continues to wear the device after performance of the user authentication. In various embodiments, the received sensor data includes data provided by the biosensor. In some embodiments in which biosensor includes a camera, the authentication system analyzes, after performance of the user authentication, a captured image (e.g., periodic signed image frame 312B) of the sensor data to determine that an eye of the user remains in a field of a view of the camera. In various embodiments, the sensor data includes sensor data provided from one or more sensors distinct from the biosensor. In some embodiments, a proximity sensor of the device provides, to the authentication system, sensor data indicative of a proximity of the user to the device; the authentication system analyzes the provided sensor data to determine whether the user remains proximal to the device. In some embodiments, a skin contact sensor of the device provides, to the authentication system, sensor data indicative of whether the user's skin is contacting the device; the authentication system analyzes the provided sensor data to determine whether the user's skin remains in contact with the device. In some embodiments, a camera provides sensor data including capture images of the user; the authentication system analyzes the provided sensor data to determine that a portion of the user remains in a field of view of the camera.

In step 515, the authentication system receives a request (e.g., authentication request 114) to confirm an authentication of the user.

In step 520, the authentication system confirms, based on the user authentication and the received sensor data, that the user has been authenticated. In various embodiments, based on the user authentication, the authentication system determines, for an initial indication period (e.g., initial user authentication 204 in timeline 200), to indicate that the user has been authenticated, receives periodic captured samples of the sensor data, and, based on the periodically captured samples, determines to extend the indication period (e.g., authentication continuity 206) without performing another biometric user authentication. In various embodiments, the authentication system receives additional sensor data indicating that the user is no longer collocated with the device and, in response to a subsequent authentication request, requires the user to perform another biometric authentication using the biosensor. In some embodiments, the authentication system analyzes the sensor data including verifying a signature (e.g., in periodic signed image frame 312B) generated from the sensor data by a sensor providing the sensor data such that confirming that the user has been authenticated is further based on a successful verification of the signature.

In various embodiments, method 500 further includes the authentication performing an initial authentication that is not based on biometric data and receiving an indication that a user has requested a particular action. Based on a stored policy, the authentication system requires the user to perform the user authentication based on the collected biometric data before granting performance of the particular action. In some embodiments, the particular action is accessing a credential securely stored in the device.

Turning now to FIG. 5B, a flow diagram of a method 530 is depicted. Method 530 is another embodiment of a method that may be performed by a device such as computing device 10. In many instances, performance of method 530 may reduce the number of times a user performs a user authentication.

In step 535, the device performs a biometric authentication (e.g., using biometric data 122) of a user in response to a first authentication request (e.g., an authentication request 114). In some embodiments, performing the biometric authentication includes analyzing a plurality of image frames captured by a camera (e.g., near eye camera 310B) positioned in front of the user's eye to compare an iris of the user with an iris of an authorized user.

In step 540, the device receives sensor data (e.g., sensor data 124) indicating that the user remains collocated with the device after performance of the biometric authentication.

In step 545, the device continues, based on the biometric authentication and the received sensor data, to indicate (e.g., via authentication confirmations 116) that the user has been authenticated in response to a second authentication request. In various embodiments, the device continually analyzes the sensor data to determine whether the user remains collocated with the device and, in response to determining that the user no longer remains collocated with the device (e.g., event detected 212), discontinue indicating that the user has been authenticated (e.g., unauthenticated state 214). In some embodiments, the analyzing includes analyzing the sensor data to determine whether the user continues to wear the device. In some embodiments, continuing to indicate that the user has been authenticated includes analyzing a periodically received image frame (e.g., periodic signed image frame 312B) from the camera and included in the sensor data to confirm that the user's eye remains in a field of view of the camera. In some embodiments, based a requested action in the second authentication request, the device reviews a policy to determine whether an expressed intent is required to grant the action in addition to the user remaining collocated with the device. In response to determining that the policy requires an expressed intent (e.g., double click button 406), the device requests that the user provide a mechanical input to the device and indicates that the user has been authenticated based on the biometric authentication, the received sensor data, and the mechanical input.

Turning now to FIG. 5C, a flow diagram of a method 560 is depicted. Method 560 is yet another embodiment of a method that may be performed by a device such as computing device 10. In many instances, performance of method 560 may improve the user experience of a user of the computing device.

Method 560 begins in step 565 with an authentication system of the device determining to indicate, for an initial time period, that a user has been authenticated based on a successful biometric authentication of the user (e.g., based on biometric data 122). In step 570, the authentication system receives sensor data (e.g., sensor data 124) indicating the user continuously maintains possession of the device. In step 570, the authentication system determines, based on the sensor data, to extend the time period in which the authentication system indicates that the user has been authenticated.

### Exemplary Computer System

Turning now to FIG. 6, a block diagram of additional components within computing device 10 is depicted. In the illustrated embodiment, computing device 10 is depicted as a head-mounted display (HMD) 600 configured to be worn on the head and to display content, such as an extended reality (XR) view 602 of an XR environment, to a user. For example, HMD 600 may be a headset, helmet, goggles, glasses, a phone inserted into an enclosure, etc. worn by a user. As noted above, however, computing device 10 may correspond to other devices in other embodiments, which may not be presenting XR content. In the illustrated embodiment, HMD 600 includes world sensors 604, user sensors 606, a display system 610, controller 620, memory 630, secure enclave processor (SEP) 640, and a network interface 650. In some embodiments, HMD 600 may be implemented differently than shown. For example, HMD 600 may include multiple network interfaces 650, HMD 600 may not include SEP 640, etc.

World sensors 604 are sensors configured to collect various information about the environment in which a user wears HMD 600. In some embodiments, world sensors 604 may include one or more visible-light cameras that capture video information of the user's environment. This information also may, for example, be used to provide an XR view 602 of the real environment, detect objects and surfaces in the environment, provide depth information for objects and surfaces in the real environment, provide position (e.g., location and orientation) and motion (e.g., direction and velocity) information for the user in the real environment, etc. In some embodiments, HMD 600 may include left and right cameras located on a front surface of the HMD 600 at positions that are substantially in front of each of the user's eyes. In other embodiments, more or fewer cameras may be used in HMD 600 and may be positioned at other locations.

In some embodiments, world sensors 604 may include one or more world mapping sensors (e.g., infrared (IR) sensors with an IR illumination source, or Light Detection and Ranging (LIDAR) emitters and receivers/detectors) that, for example, capture depth or range information for objects and surfaces in the user's environment. This range information may, for example, be used in conjunction with frames captured by cameras to detect and recognize objects and surfaces in the real-world environment, and to determine locations, distances, and velocities of the objects and surfaces with respect to the user's current position and motion. The range information may also be used in positioning virtual representations of real-world objects to be composited into an XR environment at correct depths. In some embodiments, the range information may be used in detecting the possibility of collisions with real-world objects and surfaces to redirect a user's walking. In some embodiments, world sensors 604 may include one or more light sensors (e.g., on the front and top of HMD 600) that capture lighting information (e.g., direction, color, and intensity) in the user's physical environment. This information, for example, may be used to alter the brightness and/or the color of the display system in HMD 600.

User sensors 606 are sensors configured to collect various information about a user wearing HMD 600. In some embodiments, user sensors 606 may include one or more head pose sensors (e.g., IR or RGB cameras) that may capture information about the position and/or motion of the user and/or the user's head. The information collected by head pose sensors may, for example, be used in determining how to render and display views 602 of the XR environment and content within the views. For example, different views 602 of the environment may be rendered based at least in part on the position of the user's head, whether the user is currently walking through the environment, and so on. As another example, the augmented position and/or motion information may be used to composite virtual content into the scene in a fixed position relative to the background view of the environment. In some embodiments there may be two head pose sensors located on a front or top surface of the HMD 600; however, in other embodiments, more (or fewer) head-pose sensors may be used and may be positioned at other locations.

In some embodiments, user sensors 606 may include one or more eye tracking sensors (e.g., IR cameras with an IR illumination source) that may be used to track position and movement of the user's eyes. In some embodiments, the information collected by the eye tracking sensors may be used to adjust the rendering of images to be displayed, and/or to adjust the display of the images by the display system of the HMD 600, based on the direction and angle at which the user's eyes are looking. In some embodiments, one or more of these eye tracking sensors may be used to implement biosensor 120 discussed above. In some embodiments, the information collected by the eye tracking sensors may be used to match direction of the eyes of an avatar of the user to the direction of the user's eyes. In some embodiments, brightness of the displayed images may be modulated based on the user's pupil dilation as determined by the eye tracking sensors. In some embodiments, user sensors 606 may include one or more eyebrow sensors (e.g., IR cameras with IR illumination) that track expressions of the user's eyebrows/forehead. In some embodiments, user sensors 606 may include one or more lower jaw tracking sensors (e.g., IR cameras with IR illumination) that track expressions of the user's mouth/jaw. For example, in some embodiments, expressions of the brow, mouth, jaw, and eyes captured by sensors 606 may be used to simulate expressions on an avatar of the user in a co-presence experience and/or to selectively render and composite virtual content for viewing by the user based at least in part on the user's reactions to the content displayed by HMD 600.

In some embodiments, user sensors 606 may include one or more hand sensors (e.g., IR cameras with IR illumination) that track position, movement, and gestures of the user's hands, fingers, and/or arms. For example, in some embodiments, detected position, movement, and gestures of the user's hands, fingers, and/or arms may be used to simulate movement of the hands, fingers, and/or arms of an avatar of the user in a co-presence experience. As another example, the user's detected hand and finger gestures may be used to determine interactions of the user with virtual content in a virtual space, including but not limited to gestures that manipulate virtual objects, gestures that interact with virtual user interface elements displayed in the virtual space, etc.

Display system 610 is configured to display rendered frames to a user. Display 610 may implement any of various types of display technologies. For example, as discussed above, display system 610 may include near-eye displays that present left and right images to create the effect of three-dimensional view 602. In some embodiments, near-eye displays may use digital light processing (DLP), liquid crystal display (LCD), liquid crystal on silicon (LCoS), or light-emitting diode (LED). As another example, display system 610 may include a direct retinal projector that scans frames including left and right images, pixel by pixel, directly to the user's eyes via a reflective surface (e.g., reflective eyeglass lenses). To create a three-dimensional effect in view 602, objects at different depths or distances in the two images are shifted left or right as a function of the triangulation of distance, with nearer objects shifted more than more distant objects. Display system 610 may support any medium such as an optical waveguide, a hologram medium, an optical combiner, an optical reflector, or any combination thereof. In some embodiments, display system 610 may be the transparent or translucent and be configured to become opaque selectively.

Controller 620 includes circuitry configured to facilitate operation of HMD 600. Accordingly, controller 620 may include one or more processors configured to execute program instructions to cause HMD 600 to perform various operations described herein. These processors may be CPUs configured to implement any suitable instruction set architecture, and may be configured to execute instructions defined in that instruction set architecture. For example, in various embodiments controller 620 may include general-purpose or embedded processors implementing any of a variety of instruction set architectures (ISAs), such as ARM, x86, PowerPC, SPARC, RISC, or MIPS ISAs, or any other suitable ISA. In multiprocessor systems, each of the processors may commonly, but not necessarily, implement the same ISA. Controller 620 may employ any microarchitecture, including scalar, superscalar, pipelined, superpipelined, out of order, in order, speculative, non-speculative, etc., or combinations thereof. Controller 620 may include circuitry to implement microcoding techniques. Controller 620 may include one or more levels of caches, which may employ any size and any configuration (set associative, direct mapped, etc.).

In some embodiments, controller 620 may include a GPU, which may include any suitable graphics processing circuitry. Generally, a GPU may be configured to render objects to be displayed into a frame buffer (e.g., one that includes pixel data for an entire frame). A GPU may include one or more graphics processors that may execute graphics software to perform a part or all of the graphics operation, or hardware acceleration of certain graphics operations. In some embodiments, controller 620 may include one or more other components for processing and rendering video and/or images, for example image signal processors (ISPs), coder/decoders (codecs), etc. In some embodiments, controller 620 may be implemented as a system on a chip (SOC).

Memory 630 is a non-transitory computer readable medium configured to store data and program instructions executed by processors in controller 620 such as those facilitating the authentication techniques described herein. Memory 630 may include any type of volatile memory, such as dynamic random-access memory (DRAM), synchronous DRAM (SDRAM), double data rate (DDR, DDR2, DDR3, etc.) SDRAM (including mobile versions of the SDRAMs such as mDDR3, etc., or low power versions of the SDRAMs such as LPDDR2, etc.), RAMBUS DRAM (RDRAM), static RAM (SRAM), etc. Memory 630 may also be any type of non-volatile memory such as NAND flash memory, NOR flash memory, nano RAM (NRAM), magneto-resistive RAM (MRAM), phase change RAM (PRAM), Racetrack memory, Memristor memory, etc. In some embodiments, one or more memory devices may be coupled onto a circuit board to form memory modules such as single inline memory modules (SIMMs), dual inline memory modules (DIMMs), etc. Alternatively, the devices may be mounted with an integrated circuit implementing system in a chip-on-chip configuration, a package-on-package configuration, or a multi-chip module configuration.

SEP 640 is a secure circuit configured perform various secure operations for HMD 600. As used herein, the term “secure circuit” refers to a circuit that protects an isolated, internal resource from being directly accessed by an external circuit such as controller 620. This internal resource may be memory that stores sensitive data such as personal information (e.g., biometric information, credit card information, etc.), encryptions keys, random number generator seeds, etc. This internal resource may also be circuitry that performs services/operations associated with sensitive data such as encryption, decryption, generation and verification of digital signatures, etc. For example, SEP 640 may maintain one or more cryptographic keys that are used to encrypt data stored in memory 630 in order to improve the security of HMD 600. As another example, SEP 640 may also maintain one or more cryptographic keys to establish secure connections, authenticate HMD 600 or a user of HMD 600, etc. As yet another example, SEP 640 may maintain biometric data of a user and be configured to perform a biometric authentication by comparing the maintained biometric data with biometric data collected by one or more of user sensors 606.

Network interface 650, in various embodiments, includes one or more interfaces configured to communicate with external entities. Network interface 650 may support any suitable wireless technology such as Wi-Fi®, Bluetooth®, Long-Term Evolution™, etc. or any suitable wired technology such as Ethernet, Fibre Channel, Universal Serial Bus™ (USB) etc. In some embodiments, interface 650 may implement a proprietary wireless communications technology (e.g., 90 gigahertz (GHz) wireless technology) that provides a highly directional wireless connection. In some embodiments, HMD 600 may select between different available network interfaces based on connectivity of the interfaces as well as the particular user experience being delivered by HMD 600. For example, if a particular user experience requires a high amount of bandwidth, HMD 600 may select a radio supporting the proprietary wireless technology when communicating wirelessly to stream higher quality content. If, however, a user is merely a lower-quality movie, Wi-Fi® may be sufficient and selected by HMD 600. In some embodiments, HMD 600 may use compression to communicate in instances, for example, in which bandwidth is limited.

Turning now to FIG. 7, a block diagram of SEP 640 is depicted. In the illustrated embodiment, SEP 640 includes a filter 710, secure mailbox mechanism 720, processor 730, secure ROM 740, cryptographic circuit 750, storage 752, and a biosensor pipeline 760 coupled together via an interconnect 770. In some embodiments, SEP 640 may include more (or less) components than shown in FIG. 7. As noted above, SEP 640 is a secure circuit, which may have tamper resistance. In the illustrated embodiment, SEP 640 implements tamper resistance through the use of filter 710 and secure mailbox 720.

Filter 710 is circuitry configured to tightly control access to SEP 640 to increase the isolation of the SEP 640 from the rest of computing device 10, and thus the overall security of device 10. More particularly, in some embodiments, filter 710 may permit read/write operations from processors in controller 620 (or other coupled peripherals coupled to interconnect 702 in some embodiments) to enter SEP 640 only if the operations address the secure mailbox 720. Other operations may not progress from the interconnect 702 into SEP 640. Even more particularly, filter 710 may permit write operations to the address assigned to the inbox portion of secure mailbox 720, and read operations to the address assigned to the outbox portion of the secure mailbox 720. All other read/write operations may be prevented/filtered by the filter 710. In some embodiments, filter 710 may respond to other read/write operations with an error. In one embodiment, filter 710 may sink write data associated with a filtered write operation without passing the write data on to local interconnect 770. In one embodiment, filter 710 may supply nonce data as read data for a filtered read operation. Nonce data (e.g., “garbage data”) may generally be data that is not associated with the addressed resource within the SEP 640. Filter 710 may supply any data as nonce data (e.g., all zeros, all ones, random data from a random number generator, data programmed into filter 710 to respond as read data, the address of the read transaction, etc.). Thus, filter 710 may prevent direct access to internal components 730-770 by an external entity such as controller 620.

In various embodiments, filter 710 may only filter incoming read/write operations. Thus, the components of the SEP 640 may have full access to the other components of computing device 10. Accordingly, filter 710 may not filter responses from interconnect 702 that are provided in response to read/write operations issued by SEP 640.

Secure mailbox 720 is circuitry that, in some embodiments, includes an inbox and an outbox. Both the inbox and the outbox may be first-in, first-out buffers (FIFOs) for data. The buffers may have any size (e.g. any number of entries, where each entry is capable of storing data from a read/write operation). Particularly, the inbox may be configured to store write data from write operations sourced from interconnect 702. The outbox may store write data from write operations sourced by processor 730. (As used herein, a “mailbox mechanism” refers to a memory circuit that temporarily stores 1) an input for a secure circuit until it can be retrieved by the circuit and/or 2) an output of a secure circuit until it can be retrieved by an external circuit.)

In some embodiments, software executing on controller 620 (or other peripherals coupled to interconnect 702) may request services of SEP 640 via an application programming interface (API) supported by an operating system of device 10—i.e., a requester may make API calls that request services of SEP 640. These calls may cause corresponding requests to be written to mailbox mechanism 720, which are then retrieved from mailbox 720 and analyzed by processor 730 to determine whether it should service the requests. Accordingly, this API may be used to send, via mailbox 720, for example, biometric data 122, sensor data 124, and authentication requests 114 and to receive authentication confirmations 116. By isolating SEP 640 in this manner, integrity of SEP 640 may be enhanced—including preventing, for example, a malicious process running on controller 620 from extracting ephemeral key data, biometric data, etc.

SEP processor 730 is configured to process commands received from various sources in computing device 10 and may use various secure peripherals to accomplish the commands. Processor 730 may then execute instructions stored in ROM 740 (or elsewhere such as in memory 630) such as authentication manager 742, which may use components of SEP 640 to facilitate performing various actions described above with respect to authenticating a user. For example, in response to receiving an authentication request 114, SEP processor 730 may execute manager 742 to provide appropriate commands to biosensor 120 and biosensor pipeline 760 to capture and compare biometric data 122. Manager 742 may also analyze sensor data 124 to determine whether to extend the user's authentication period and may provide a corresponding authentication confirmation 116. In some embodiments, manager 742 further provide commands to cryptographic circuit 750 to decrypt biometric data 122 and sensor data 124 as well as verify any signatures included data 122 and 124. Manager 742 may also facilitate other forms of authentication such as those noted above with FIG. 1.

Secure ROM 740 is a memory configured to store program instruction for booting SEP 640. In some embodiments, ROM 740 may respond to only a specific address range assigned to secure ROM 740 on local interconnect 770. The address range may be hardwired, and processor 730 may be hardwired to fetch from the address range at boot in order to boot from secure ROM 740. Filter 710 may filter addresses within the address range assigned to secure ROM 740 (as mentioned above), preventing access to secure ROM 740 from components external to the SEP 640. In some embodiments, secure ROM 740 may include other software executed by SEP processor 730 during use. This software may include the program instructions to process inbox messages and generate outbox messages, etc. In some embodiments, program instructions executed by SEP processor 730 are signed by a trusted authority (e.g., devices 10's manufacturer) in order to ensure their integrity. These program instructions may include those stored in secure ROM 740 and program instructions stored externally such as in memory 630; however, these externally stored program instructions may have their signatures verified by program instructions in ROM 740 prior to being permitted to be executed by processor 730.

Cryptographic circuit 750 is circuitry configured to perform cryptographic operations for SEP 640, including key generation as well as encryption and decryption using keys, which may be stored in storage 752 (or stored externally such as in memory 630 in a protected manner). Cryptographic circuit 750 may implement any suitable encryption algorithm such as Data Encryption Standard (DES), Advanced Encryption Standard (AES), Rivest Shamir Adleman (RSA), Digital Signature Algorithm (DSA), etc. In some embodiments, circuit 750 may further implement elliptic curve cryptography (ECC). In some embodiments, circuit 750 may be responsible for establishing the secure channels between SEP 640 and other elements such as biosensor 120, sensors providing sensor data 124, etc. Accordingly, circuit 750 may use communication keys 754 to encrypt and decrypt communications between SEP 640 and biosensor 120 (and any source of sensor data 124). In some embodiments, circuit 750 may also verify signatures included in data 122 and 124 using stored public keys. In some embodiments, circuit 750 may generate communications keys 754 in response to a command from manager 742 and using a random number generator (RNG) circuit, which may be included in circuit 750 or accessible to circuit 750 as a secure peripheral via interconnect 770. In some embodiments, SEP 640 may predicate use of particular keys associated with secure data on a successful user authentication. Accordingly, prior to accessing confidential data secured by a particular cryptographic key maintained by SEP 640, computing device 10 may send a corresponding authentication request 114 also requesting access to the data. In response to receiving an authentication request 114, SEP 640 may verify the user's identity (using manager 742, pipeline 760, or some other component). In response to the verifying being successful, SEP 640 may determine to permit circuit 750 to use of the particular key, which may include circuit 750 deriving the cryptographic key and using it to decrypt the secured data (or another key granting access to the data).

Storage 752 is a local memory (i.e., internal memory) of SEP 640 configured to store key data, which may include communication keys 754, public keys for verifying signatures in data 122 and 124, etc. In some embodiments, storage 752 may be configured such that only cryptographic circuit 750 is able to read and write data to storage 752 including key 754. For example, while key manager 742 running on processor 730 may be able to request performance of an action with respect to keys 754, processor 730 may not be able to read or write data to storage 752. Thus, if processor 730 were to execute compromised program instructions, processor 730 would be unable to read and write keys 754 anyways as storage 752 may, for example, lack the physical read and write interfaces to facilitate such actions for processor 730. In some embodiments, cryptographic circuit 750 may access other forms of storage, which may include other non-volatile storages such as listed above with respect to FIG. 6. In some embodiments, these other storages may also include a set of fuses that are burnt during a fabrication of SEP 640 (or more generally device 10) in order to record keys such as a unique identifier (UID), which may be used derive keys described herein such as key 754 or other key data. In some embodiments, to expand its available storage, SEP 640 may store keys generated by cryptographic circuit 750 externally to SEP 640, such as in a non-volatile storage, but encrypt those keys using one or more keys stored in storage 752 or other internal storages.

Biosensor sensor pipeline 760, in various embodiments, is circuitry configured to authenticate a user by comparing biometric data 122 captured by a biosensor 120 from a user being authenticated with a biometric data 762 of an authorized user. (In other embodiments, data 122 and 762 may be compared by software such as authentication manager 742.) In some embodiments, pipeline 760 may perform the comparison using a collection of neural networks included in pipeline 760, each network being configured to compare biometric data 122 captured in a single frame with biometric data 762 captured in multiple frames for an authorized user. As shown, pipeline 760 may be configured to read, from memory 630, biometric data 762, which may be protected by encryption in some embodiments and/or be stored in an associated part of memory 630 that is only accessible to SEP 640. (In another embodiment, SEP 640 may store biometric data 762 internally.) Based on the comparison of biometric data 122 and 762, pipeline 760 may provide an authentication result/confirmation 116 indicating whether the authentication was successful or failed.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . W, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112 (f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. A device, comprising:
a biosensor configured to collect biometric data from a user; and
an authentication system configured to:
perform a user authentication based on the collected biometric data;
after performance of the user authentication:
receive sensor data indicating that the user remains collocated with the device;
receive a request to confirm an authentication of the user; and
based on the user authentication and the received sensor data, confirm that the user has been authenticated.

2. The device of claim 1, wherein the authentication system is configured to:
based on the user authentication, determine to indicate, for an initial indication period, that the user has been authenticated;
receive periodic captured samples of the sensor data; and
based on the periodically captured samples, determine to extend the indication period without performing another biometric user authentication.

3. The device of claim 1, wherein the authentication system is configured to:
receive additional sensor data indicating that the user is no longer collocated with the device; and
in response to a subsequent authentication request, require the user to perform another biometric authentication using the biosensor.

4. The device of claim 1, wherein the device is a wearable device; and
wherein the authentication system is configured to:
analyze the sensor data to confirm that the sensor data indicates that the user continues to wear the device after performance of the user authentication.

5. The device of claim 1, wherein the received sensor data includes data provided by the biosensor.

6. The device of claim 1,
wherein the biosensor includes a camera configured to:
capture images of an eye of the user; and
wherein the authentication system is configured to:
perform the user authentication by comparing an iris in a sequence of the captured images to an iris of an authorized user; and
after performance of the user authentication, analyze a captured image of the sensor data to determine that an eye of the user remains in a field of a view of the camera.

7. The device of claim 6, wherein the camera is configured to:
provide ones of the captured images to the authentication system; and
provide ones of the captured images to a gaze tracking system of the device.

8. The device of claim 1, wherein the sensor data includes sensor data provided from one or more sensors distinct from the biosensor.

9. The device of claim 8, further comprising:
a proximity sensor configured to:
provide, to the authentication system, sensor data indicative of a proximity of the user to the device; and
wherein the authentication system is configured to:
analyze the provided sensor data to determine whether the user remains proximal to the device.

10. The device of claim 9, further comprising:
a skin contact sensor configured to:
provide, to the authentication system, sensor data indicative of whether the user's skin is contacting the device; and
wherein the authentication system is configured to:
analyze the provided sensor data to determine whether the user's skin remains in contact with the device.

11. The device of claim 1, further comprising:
a camera configured to:
provide sensor data including capture images of the user; and
wherein the authentication system is configured to:
analyze the provided sensor data to determine that a portion of the user remains in a field of view of the camera.

12. The device of claim 1, wherein the authentication system is configured to:
analyze the sensor data including verifying a signature generated from the sensor data by a sensor providing the sensor data, wherein confirming that the user has been authenticated is further based on a successful verification of the signature.

13. The device of claim 1, wherein the authentication system is configured:
perform an initial authentication that is not based on biometric data;
receive an indication that a user has requested a particular action; and
based on a stored policy, require the user to perform the user authentication based on the collected biometric data before granting performance of the particular action.

14. The device of claim 13, wherein the particular action is accessing a credential securely stored in the device.

15. A non-transitory computer readable medium having program instructions stored therein that are executable by a device to perform operations comprising:
performing a biometric authentication of a user in response to a first authentication request;
receiving sensor data indicating that the user remains collocated with the device after performance of the biometric authentication; and
based on the biometric authentication and the received sensor data, continuing to indicate that the user has been authenticated in response to a second authentication request.

16. The computer readable medium of claim 15, wherein the operations further comprise:
continually analyzing the sensor data to determine whether the user remains collocated with the device; and
in response to determining that the user no longer remains collocated with the device, discontinuing indicating that the user has been authenticated.

17. The computer readable medium of claim 16, wherein the analyzing includes:
analyzing the sensor data to determine whether the user continues to wear the device.

18. The computer readable medium of claim 15,
wherein performing the biometric authentication includes:
analyzing a plurality of image frames captured by a camera positioned in front of the user's eye to compare an iris of the user with an iris of an authorized user; and
wherein continuing to indicate that the user has been authenticated includes:
analyzing a periodically received image frame from the camera and included in the sensor data to confirm that the user's eye remains in a field of view of the camera.

19. The computer readable medium of claim 15, wherein the operations further comprise:
based a requested action in the second authentication request, reviewing a policy to determine whether an expressed intent is required to grant the action in addition to the user remaining collocated with the device;
in response to determining that the policy requires an expressed intent, requesting that the user provide a mechanical input to the device; and
indicating that the user has been authenticated based on the biometric authentication, the received sensor data, and the mechanical input.

20. A method comprising:
determining, by an authentication system of a device, to indicate, for an initial time period, that a user has been authenticated based on a successful biometric authentication of the user;
receiving, by the authentication system, sensor data indicating the user continuously maintains possession of the device; and
based on the sensor data, determining, by the authentication system, to extend the time period in which the authentication system indicates that the user has been authenticated.
